(19) United States
(12) Patent Application Publication
(10) Pub. No.: US 2002/0139663 A1
(43) Pub. Date: Oct. 3, 2002

(54) Chemical treatment system

(75) Inventors: Katsuya Kosaki, Tokyo (JP); Takeo Nakamoto, Hyogo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/093,417

(22) Filed: Mar. 11, 2002

Related U.S. Application Data
(63) Continuation-in-part of application No. 09/919,875, filed on Aug. 2, 2001.

(30) Foreign Application Priority Data
Apr. 2, 2001 (JP) 2001-103431
Nov. 28, 2001 (JP) 2001-363086

(51) Int. Cl. C25B 15/00; C02F 1/40; C25B 9/00

(52) U.S. Cl. 204/237

(57) ABSTRACT

By means of a pump for supplying a processing fluid such as a plating fluid to a closed processing cup such as a closed plating cup, at least either the pressure or flow rate of the processing fluid or plating fluid circulating within the closed processing cup or the closed plating cup is cyclically changed. Further, the direction of circulation of the processing fluid circulating within the closed processing cup is also changed cyclically. Under a method of manufacturing a semiconductor device and a method of manufacturing a printed board, a semiconductor wafer and a printed board are disposed in the closed plating cup such that blind holes formed by closing openings on one end of via holes or openings on one end of through holes are brought into contact with a circulating plating fluid, thereby eliminating air bubbles that remain. As a result, a manufacturing yield or performance of a product is improved.

### BACKGROUND OF THE INVENTION

1. Field of the Invention

The present invention relates to a plating system and method for plating a member to be plated through use of a closed-type plating cup, to a method of manufacturing a semiconductor device using the plating system and method, and further to a method of manufacturing a printed board using-the plating method and system.

2. Background Art

A semiconductor device is constituted of, for example, a semiconductor substrate made of a group IV compound such as silicon or a group III-V compound such as gallium arsenide (GaAs). Via holes are formed to penetrate through a semiconductor substrate so as to feed power to a semiconductor substrate of a completed semiconductor device or so as to impart the ground potential to the semiconductor substrate. The interior surface of each of the via holes is often plated with gold (Au) or the like. Processes of manufacturing the semiconductor device include a plating process of plating a semiconductor wafer before the wafer is sliced into a plurality of semiconductor chips. In each of the semiconductor chips, a via hole is formed. In the plating process, a plating layer is formed on the interior surface of each of the via holes while one of the ends of each via hole is closed; that is, each of the via holes is held as a blind hole.

In a process of manufacturing a semiconductor device having such a via hole, the via hole is formed through, e.g., reactive ion etching. Residues, such as organic polymer including carbon, or chlorine produced during the course of reactive ion etching, remain on the interior surface of the via hole formed through reactive ion etching. For this reason, the process includes a residue elimination process for eliminating the residues. Further, the process includes an electroless plating process of forming a feeding layer on the interior surfaces of the via holes through electroless plating before a plating layer is formed on the interior surfaces of the via holes from which the residues have been removed.

In a multilayer printed board, through holes are formed in a printed board. A plating layer of copper (Cu) or the like is formed on the surface of each of the through holes, including an interior surface. The plating layer is used for interlayer connection between layers of a multilayer printed board. In some cases, through holes formed in the printed board are also plated while one end of each of the through holes is closed; that is, the through holes are held in the state of blind holes.

When a plating layer is formed on a blind hole of the printed board, the manufacturing process also includes an electroless plating process for forming a plating layer on the interior surface of the blind hole through electroless plating.

A plating system having a closed plating cup is usually used for effecting the foregoing plating operation. The closed plating cup subjects a semiconductor wafer or a printed board to electrolyticplating, by means of circulating a plating fluid at a certain pressure and at a certain flow rate within a closed internal processing chamber. A member to be plated, such as a semiconductor wafer or a printed board, is disposed within the closed plating cup such that open ends of respective via holes or through holes are oriented faceup. A plating layer is formed on the surface of each of the blind holes, including an interior surface, by means of electrolysis of the plating fluid.

A treatment system having a closed-type processing cup is usually used in the process of eliminating residues from via holes of a semiconductor device, in the electroless plating process, and in the process of subjecting a printed board to electroless plating. The closed-type processing cup eliminates residues from via holes of a semiconductor wafer, effects electroless plating, and subjects through holes of the printed board to electroless plating, by means of circulating a treatment fluid through a closed internal processing chamber at a certain pressure and flow rate. The treatment is effected in a face-up style in which the semiconductor wafer and the printed board are subjected to treatment while their via holes and through holes are oriented upward. Moreover, the semiconductor wafer and the printed board are disposed in the closed-type processing cup such that the openings are brought into contact with the circulating treatment fluid. As a result of the via holes and through holes being brought into contact with the treatment fluid, elimination of residues from surfaces, including the interior surfaces of the blind holes, and formation of an electroless plating layer are performed.

In relation to a plating operation for forming a plating layer on the surface of such a blind hole, including an interior surface, air bubbles arising in the blind hole pose a problem. A faceup style is effective for diminishing the amount of air bubbles arising in a blind hole. However, despite adoption of the faceup style, a problem of air bubbles still remains unsolved. Particularly when the aspect ratio of a blind hole becomes higher such that hole depth becomes greater than hole diameter, occurrence of air bubbles in a blind hole cannot be avoided. If air bubbles remain in the same location, a plating fluid fails to come into contact with a portion of the interior surface corresponding to the location. Consequently, failures arise in the plating layer. The plating failures result in disconnection of a plating layer or an increase in electric resistance. In turn, this accounts for a drop-off in manufacturing yield or for deterioration of performance of a completed semiconductor device or printed board.

### SUMMARY OF THE INVENTION

The present invention proposes a chemical treatment system, a chemical treatment method, and a residue elimination method, which are improved so as to enable performance of such residue elimination treatment, formation of an electroless plated layer, and inhibition of occurrence of deficiencies in an electrochemically-plated layer.

The present invention proposes a plating system and a plating method which have been improved so as to be able to prevent occurrence of plating failures.

The present invention proposes a method of manufacturing an improved semiconductor device and a method of manufacturing a printed board, which methods are improved so as to be able to hamper occurrence of plating failures.

According to one aspect of the present invention, a chemical treatment system comprises a closed processing cup, a fluid reservoir tank and a pump for supplying the treatment fluid. The closed processing cup subjects a member to be treated to chemical treatment while circulating therein a treatment fluid at a certain pressure and a certain flow rate. The fluid reservoir tank stores the treatment fluid. The pump supplies the treatment fluid from the fluid reservoir tank to the closed processing cup, wherein the pump periodically changes at least either the pressure or flow rate of the treatment fluid in the closed processing cup.

In another aspect of the present invention, in the chemical treatment system, the pump is preferably constituted of a pulsating pump, and the pulsating pump periodically changes at least either the pressure or flow rate of the treatment fluid in the closed processing cup.

In another aspect of the present invention, the chemical treatment system preferably further comprises a supply channel for supplying the treatment fluid to the closed processing cup, a discharge channel for discharging the treatment fluid from the closed processing cup, and a flow throttle valve provided in the discharge channel.

According to another aspect of the present invention, a chemical treatment system comprises a closed processing cup, a fluid reservoir tank and a pumping apparatus for supplying the treatment fluid. The closed processing cup subjects a member to be treated to chemical treatment while circulating therein a treatment fluid at a certain pressure and a certain flow rate. The fluid reservoir tank stores the treatment fluid. The pumping apparatus supplies the treatment fluid from the fluid reservoir tank to the closed processing cup, wherein the flowing direction of the treatment fluid within the closed processing cup is periodically changed.

In another aspect of the present invention, in the chemical treatment system, the closed processing cup has preferably first and second treatment fluid flow ports, and the pumping apparatus has preferably first and second pumps. Further, the first pump circulates the treatment fluid in the closed processing cup from the first treatment fluid flow port to the second treatment fluid flow port, and the second pump circulates the treatment fluid in the closed processing cup from the second treatment fluid flow port to the first treatment fluid flow port.

In another aspect of the present invention, the chemical treatment preferably further comprises a first treatment fluid channel to be connected to the first treatment fluid flow port of the closed processing cup and a second treatment fluid channel to be connected to the second treatment fluid flow port of the closed processing cup. A first flow regulation valve is provided in the first treatment fluid flow channel; and a second flow regulation valve provided in the second treatment fluid flow channel. When the treatment fluid flows from the first treatment fluid flow port to the second treatment fluid flow port in the closed processing cup, the second flow regulation valve provided in the second treatment fluid flow channel connected to the second treatment fluid flow port is taken as a flow throttle valve, and when the treatment fluid flows from the second treatment fluid flow port to the first treatment fluid flow port, the first flow regulation valve provided in the first treatment fluid flow channel connected to the first treatment fluid flow port is taken as a flow throttle valve.

Other and further objects, features and advantages of the invention will appear more fully from the following description.

### BRIEF DESCRIPTION OF THE DRAWINGS

FIG. 1 is a view showing the overall configuration of a chemical processing system (or a plating system) according to the present invention.

FIG. 2 shows an example of a configuration of a closed-type processing cup (or a closed-type plating cup) in the present invention.

FIG. 3 shows a partial enlarged view of FIG. 2 at a portion of a ring-shaped seal member.

FIGS. 4(a) and 4(b) show a plating layer formation step of a chemical processing method (or a plating method) of the present invention.

FIGS. 5(a) through 5(d) show an another embodiment of chemical processing method (or plating layer formation method) in the present invention.

FIG. 6 is a view showing the overall configuration of a chemical processing system (or a plating system) according to a third embodiment of the present invention.

FIG. 7 is a view showing the overall configuration of a chemical processing system (or a plating system) according to a fourth embodiment of the present invention.

FIG. 8 is a view showing the overall configuration of a chemical processing system (or a plating system) according to a fifth embodiment of the present invention.

### DETAILED DESCRIPTION OF THE PREFERRED EMBODIMENTS

First Embodiment

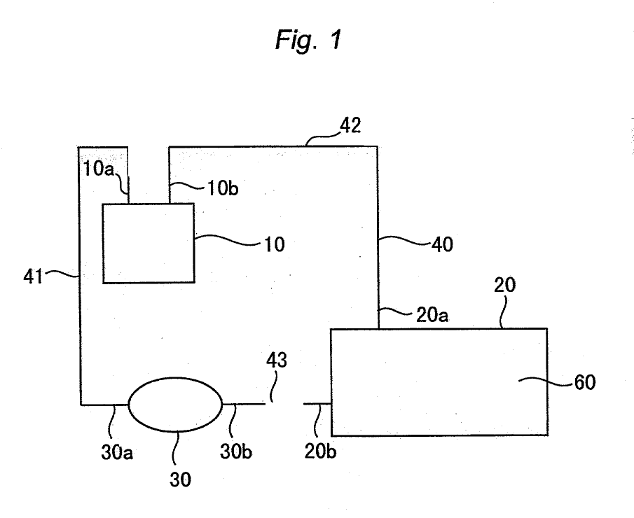

FIG. 1 is a view showing the overall configuration of a plating system according to the present invention. The plating system comprises a closed plating cup 10; a reservoir tank 20 for reserving a plating fluid; a pump 30 for supplying a plating fluid to the closed plating cup 10; and a plating fluid circulation path 40 including the plating cup 10, the reservoir tank 20, and the pump 30.

The closed plating cup 10 is provided with a set of plating fluid circulation ports 10a and 10b in communication with an internal processing chamber of the cup 10. Here, the plating fluid circulation port 10a constitutes a plating fluid supply port, and the plating fluid circulation port 10b constitutes a plating fluid outlet port. The reservoir tank 20 has a plating fluid inlet port 20a and a plating fluid outlet port 20b. Further, the pump 30 has a plating fluid outlet port 30a and a plating port inlet port 30b. The plating fluid outlet port 30a of the pump 30 is connected to the plating fluid supply port 10a of the closed plating cup 10 by means of a pipe 41. The pipe 41 constitutes a channel for supplying a plating fluid to the closed plating cup 10. The plating fluid outlet port 10b of the closed plating fluid cup 10 is connected to the plating fluid inlet port 20a of the reservoir tank 20 by means of the pipe 42. The pipe 42 constitutes a plating fluid outlet channel of the closed plating cup 10. The plating fluid outlet port 20b of the reservoir tank 20 is connected to the inlet port 30b of the pump 30. Plating fluid 60 is stored in the reservoir tank 20 and circulated in the plating system.

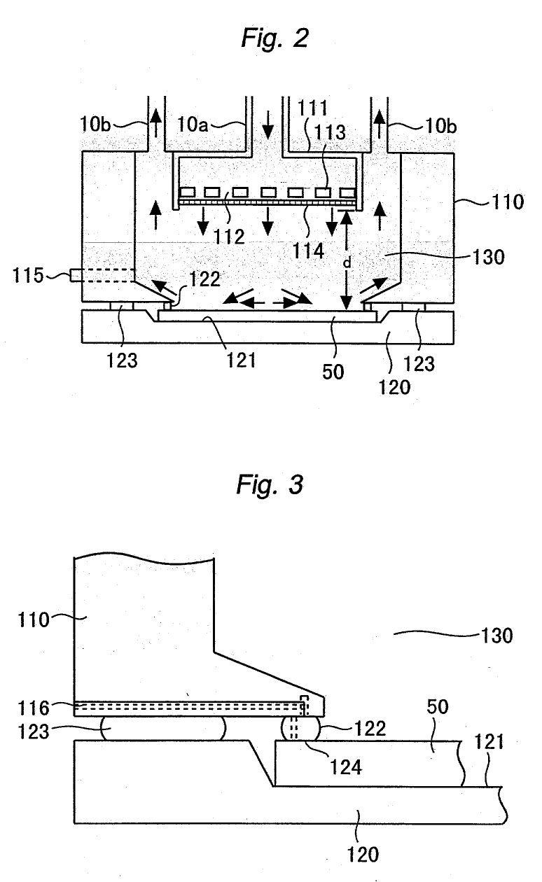

FIG. 2 shows an embodiment of the closed plating cup 10. The closed plating cup 10 has an upper cup 110 and a lower cup 120. The upper cup 110 and the lower cup 120 constitute a closed processing chamber 130. A lower portion of the upper cup 110 is opened, and the plating fluid circulation port 10a is provided in substantially the upper center of the upper cup 110. Further, the plating fluid circulation port 10b is provided on either side of the plating fluid circulation port 10a. A plating fluid squirting section 111 is formed from a cylindrical member having an opened lower portion. A plating fluid squirting plate 113 having a plurality of plating fluid squirting holes 112 is provided at the open end of the plating fluid squirting section 111. Further, the plating fluid squirting plate 113 has a mesh anode electrode 114. A drain pipe 115 is provided in a lower portion of the upper cup 110 for collecting plating fluid or discharging wash water. The lower end of the plating fluid squirting section 111 is spaced away from and disposed opposite a top surface of a member 50 to be plated, with an interstice “d” provided therebetween. The hydraulic pressure within the cup 10 can be changed by means of changing the interstice “d.”

The lower cup 120 is formed in the shape of a plate and is combined with the upper cup 110 so as to close the bottom of the upper cup 110. A depression 121 on which the member 50 is to be mounted is formed in the center of the lower cup 120. The member 50 is, for example, a semiconductor wafer or a printed board. A ring-shaped seal member 122 is provided between an outer periphery of an upper surface of the member 50 and the bottom surface of the upper cup 110, thereby sealing the processing chamber 130 so as to prevent leakage of plating fluid from the processing chamber 130. A similar ring-shaped auxiliary seal member 123 is provided around and outside the seal member 122. The auxiliary seal member 123 is sandwiched between the bottom surface of the upper cup 110 and the lower cup 120.

As shown in FIG. 3 in an enlarged manner, the ring-shaped seal member 122 is provided with a cathode contact 124. The cathode contact 124 is a needle or wire provided so as to penetrate through the ring-shaped seal member 122 in a plurality of locations. The cathode contact 124 is in point contact with the member 50, thereby imparting a cathode potential to the member 50. Although a d.c. power supply to be used for plating is not illustrated, the anode of the d.c. power supply is connected to the mesh anode electrode 114, and the cathode of the d.c. power supply is connected to the cathode contact 124. A release 116 of the seal member 122 for squirting a gas or pure water is provided on the bottom of the upper cup 110. The release 116 is in communication with a supply source of gas or pure water.

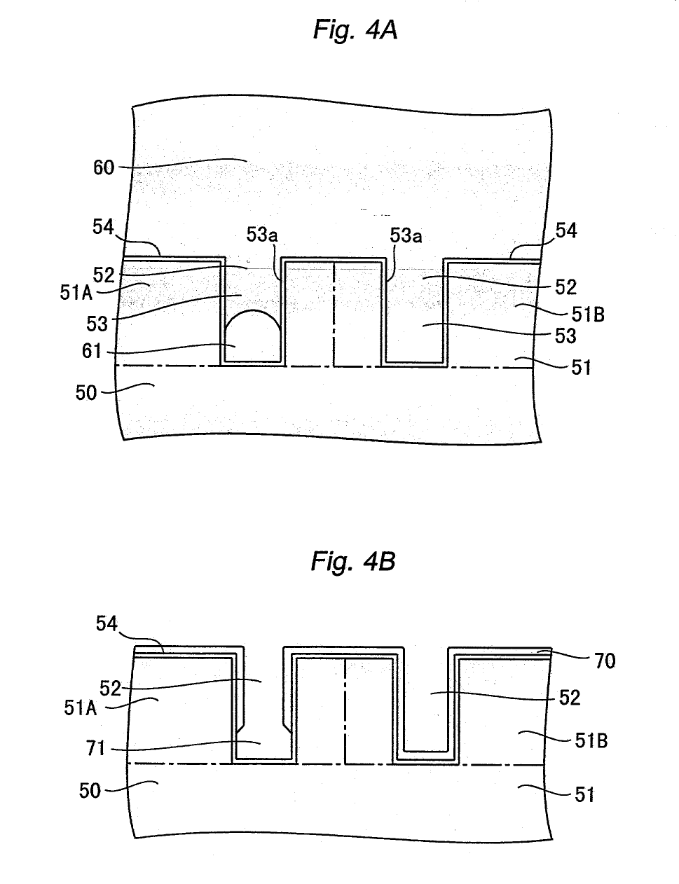

FIGS. 4(a) and 4(b) show a plating layer formation step of a plating method for plating the member 50 through use of the plating system according to the first embodiment, to thereby form a plating layer. FIGS. 4(a) and 4(b) also show a plating process of a method of manufacturing a semiconductor device. The member 50 which is to undergo the plating process corresponds to, e.g., a semiconductor wafer. The member 50 includes a semiconductor substrate 51 formed from, e.g., silicon or gallium arsenide. The semiconductor substrate 51 includes a plurality of semiconductor substrate portions. FIGS. 4(a) and 4(b) show two semiconductor substrate sections 51A and 51B separated from each other by means of a phantom line. In a completed semiconductor device, the semiconductor substrate portions 51A and 51B are separated individually from each other along the phantom line. The thus-separated semiconductor substrate portions 51A and 51B are to become semiconductor substrates of respective semiconductor devices, the substrates being called chips. Reference numeral 60 designates a plating fluid.

In relation to the semiconductor wafer 50, a blind hole 53 which is to become a via hole is formed in each of the semiconductor substrate portions 51A and 51B. The semiconductor wafer 50 undergoes plating while a lower end of each of the blind holes 51 is closed and an upper end of each of the blind holes 51 is opened. The semiconductor wafer 50 is disposed in a processing chamber 130 of the closed plating cup 10 such that an upper open end of each of the blind holes 53 is oriented upward and comes into contact with the circulating plating fluid 60. The manner in which the semiconductor wafer 50 is disposed such that the upper end of each of the blind holes 53 is oriented up is called the face-up style.

As compared with a facedown style in which the open end of each of the blind holes 53 is oriented downward, the face-up style is more effective for diminishing the amount of air bubbles developing in each of the blind holes 53 during a plating operation. In the facedown style, the closed opening of each of the blind holes 53 is oriented upward, and hence there is a high risk of air bubbles being captured in the blind holes 53.

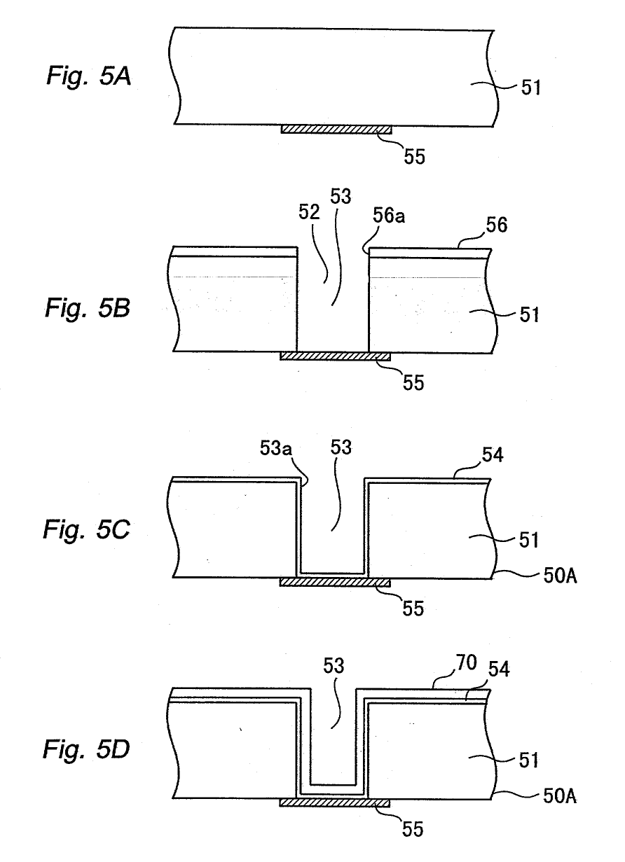

A thin feeding layer 54 is formed beforehand on the top of the semiconductor wafer 50, including interior surfaces 53a of the blind holes 53. A cathode potential is applied to the feeding layer 54 from the cathode contact 124. Consequently, a plating layer 70 is formed on the feeding layer 54. After completion of the plating operation, the bottom of the semiconductor wafer 50 is eliminated by means of, e.g., abrasion, until the respective via holes 52 become through holes. As shown in FIGS. 5(a) through 5(d), when via holes are formed after the semiconductor wafer 50 has been made thin, the semiconductor wafer 50 is made thin before formation of via holes through abrasion.

Even in the face-up plating system, air bubbles 61 sometime develop and remain in the blind holes 53. In relation to the semiconductor wafer 50 in which via holes having a high aspect ratio are formed, the width of the blind hole 53 becomes smaller and the depth of the same becomes greater. Hence, there is increased the risk of the air bubbles 61 developing and remaining in the blind holes 53. In FIG. 4(a), an air bubble 61 develops in a left-side blind hole 53. If the air bubble 61 remains during a plating operation, a plating failure 71 arises, as shown in FIG. 4(b).

When a plating layer 70 made of gold (Au) is formed on the semiconductor wafer 50 formed from GaAs, a sulfurous-acid-based plating fluid or a cyan-based plating fluid is used as the plating fluid 60. For instance, the sulfurous-acid-based plating fluid is composed primarily of gold sodium sulfite and sodium sulfite. The cyan-based plating fluid is composed primarily of gold cyanide sulfite. During a plating operation, the plating fluid 60 assumes a temperature ranging from 40(C to 70(C; for example, a recommended temperature of 50(C or 65(C. The dynamic viscosity of the plating fluid 60 assumes a value of, e.g., 0.6 to 0.8 m2/sec.

The closed plating cup 10 is effective for imparting a certain pressure and flow rate to a plating fluid in the processing chamber 130 of the cup 10. Use of the closed plating cup 10 enables a reduction in the amount of air bubbles 61 developing and remaining in the blind holes 53. Pressure applied to the plating fluid in the processing chamber 130 provided in the closed plating cup 10 is set to a high value of, e.g., 1000 Pa or greater. Such a high pressure is effective for reducing the likelihood of the air bubbles 61 arising and remaining in the blind holes 53.

In the first embodiment, a pulsating pump is used as the pump 30 for supplying a plating fluid to the processing chamber 130 of the closed plating cup 10. More specifically, a bellows pump or a diaphragm pump is used as the pulsating pump 30. A bellows pump pumps a plating fluid into the processing chamber 130 of the closed plating cup 10 by means of pulsating action of a bellows. The pressure and flow rate of the plating fluid within the processing chamber 130 change cyclically in accordance with the cycle of pulsating action. Similarly, even in the case of a diaphragm pump, the pressure and flow rate of the plating fluid within the processing chamber 130 change cyclically in accordance with pulsating action of a diaphragm. In a bellows pump or a diaphragm pump, the pressure of the plating fluid in the processing chamber 130 changes in a pulse-like manner in accordance with a cycle of pulsating action.

The plating system and the plating method, in which a pulsating pump is used as the pump 30 to thereby cyclically change the pressure and flow rate of a plating fluid in the processing chamber 130, are effective for diminishing the likelihood of the air bubbles 61 developing and remaining in the blind holes 53. The air bubble 61 remaining means that the developed air bubble 61 remains in the same location during a plating operation. Cyclic changes in the pressure and flow rate of the plating fluid in the processing chamber 130 ascribable to the pulsating pump 30 are effective for moving the air bubble 61 from the location where it has developed and for preventing the air bubble 61 from remaining in the same location. The method of manufacturing a semiconductor device according to the present invention lessens the likelihood of plating failures, which in turn improves a manufacturing yield of a semiconductor device to be manufactured by way of the plating process or improves the performance of a semiconductor device.

More specifically, a bellows pump is used as the pump 30, and the pressure applied to the plating fluid at the outlet port 30a is set to a value of 0.12 MPa (mega pascals). Further, a plating fluid is circulated at a flow rate of 13 liters /min. When the pulsating cycle of the bellows pump is set to 68 shots/min., plating failures ascribable to the air bubbles 61 remaining can be solved completely. The pressure of the plating fluid in the processing chamber 130 is dependent on the interstice “d” shown in FIG. 2; namely, the length of an interstice between the lower end of the plating fluid squirting section 11 and the member 50 to be plated. Hence, the interstice “d” is set to the value ranging from 5 to 6 millimeters.

Second Embodiment

A plating method according to the present invention is shown in sequential order of steps. The plating system described in connection with the first embodiment is used in the plating method.

The second embodiment shows plating processes of the method of manufacturing a semiconductor device. The second embodiment employs a semiconductor wafer 50A in which one end of each of the blind holes 53 is partially covered with a cover member. FIGS. 5(a) through 5(d) show processes of producing the semiconductor wafer 50A having such blind holes 53; namely, processes ranging from a plating preparation process to a plating process.

FIG. 5(a) shows a first preparation step. In this step, cover members 55 formed from gold (Au) are bonded to a lower surface—namely, at predetermined areas on the back surface—of the semiconductor substrate 51, which is formed from, e.g., gallium arsenide (GaAs), and has a thickness ranging from 30 micrometers to 150 micrometers. The cover members 55 are attached to respective positions in which via holes 52 are to be formed. FIG. 5(b) shows a second preparation step, wherein a resist film 56 is formed on the upper surface of the semiconductor substrate 51. Openings 56a are formed at positions on the resist film 56 where the via holes 52 are to be formed. The semiconductor wafer 50A is etched in this state, whereby the via holes 52 are formed. The via holes 52 are formed so as to penetrate through the semiconductor substrate 51. Lower-end openings of the respective via holes 52 are closed by the cover members 55, thereby constituting the blind holes 53. FIG. 5(c) shows a third preparation step, in which the resist film 56 is removed and a thin feeding layer 54 is formed on the upper surface of the semiconductor substrate 51, including interior surfaces 53a of the blind holes 53. The feeding layer 54 corresponds to a thin film which is formed from, e.g., nickel (Ni)/gold (Au), titanium (Ti)/gold (Au), or chromium (Cr)/gold (Au), by means of sputtering or electroless plating.

FIG. 5(d) shows a plating process. A plating layer 70 made of, e.g., gold (Au), is formed in the processing chamber 130 of the closed plating cup 10. During the plating process, the semiconductor substrate 51 is plated while the openings of the blind holes 53 are oriented upward and remain in contact with the plating fluid circulating through the processing chamber 130. A pulsating pump is used as the pump 30, and the pressure and flow rate of the plating fluid in the processing chamber 130 vary in accordance with a pulsating cycle of the pulsating pump, thereby preventing any air bubbles 61 from remaining.

A method of manufacturing a printed board is also identical with that shown in FIGS. 5(a) through 5(d). A printed board is formed from a dielectric board. A predetermined circuit pattern is formed from a copper layer on each of a pair of principal planes. Simultaneously, through holes are formed in predetermined areas so as to penetrate through the dielectric board. With the through holes being taken as blind holes, the printed board is plated in the same manner as shown in FIG. 5(d). Eventually, plating layers provided on the interior surfaces of the through holes electrically interconnect predetermined circuit patterns provided on the respective principal planes. More specifically, the printed board is plated in the processing chamber 130 of the closed plating cup 10 while being oriented upward, such that the through holes formed in the board are opened at one end and closed at the other end, like the blind hole shown in FIG. 5(c). Any air bubbles that remain in the blind holes are effectively discharged by means of pulsating action of the pump 30, thereby lessening the likelihood of plating failures. By means of the method for lessening the likelihood of plating failures, a manufacturing yield of a print board is improved, or the performance of a printed board is improved.

Third Embodiment

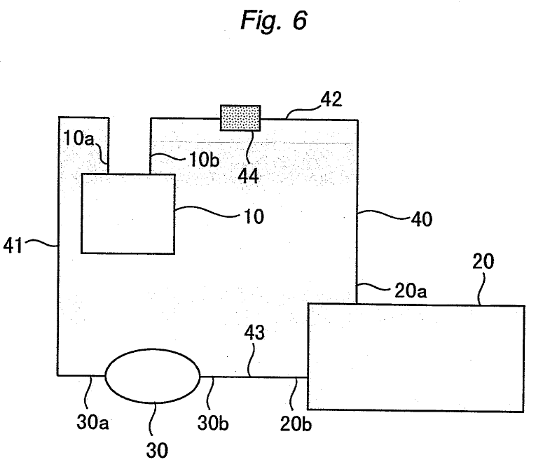

FIG. 6 is a view showing the overall configuration of a plating system according to a third embodiment of the present invention. The plating system according to the third embodiment is used for the plating method according to the present invention. Further, the plating system is employed in plating processes of the method of manufacturing a semiconductor device and in those of the method of manufacturing a printed board, both pertaining to the present invention. In the third embodiment, further improvements are made to the plating system according to the first embodiment shown in FIG. 1. Elements, which are the same as those shown in FIG. 1, are assigned the same reference numerals. In the third embodiment, a flow-rate throttle valve 44 is attached to the plating fluid circulation port 10b of the closed plating cup 10; that is, a plating fluid outlet port.

The flow-rate throttle valve 44 limits the flow rate of plating fluid flowing through the plating fluid outlet port 10b of the closed plating processing cup 10, thereby increasing the internal pressure of the processing chamber 130 of the closed plating processing cup 10. The flow-rate throttle valve 44 facilitates adjustment of the pressure of plating fluid in the processing chamber 130 to a higher level. Thus, the flow-rate throttle valve 44 is effective for preventing occurrence of plating failures, which would otherwise be caused by trapped air. The flow-rate throttle valve 44 is not limited to the plating fluid outlet port 10b but may also be provided at the pipe 43 for interconnecting the placing cup 10 and the fluid reservoir tank 20. Here, as the throttle valve 44 is disposed closer to the plating fluid outlet port 10b, the plating-failure prevention effect becomes greater.

Fourth Embodiment

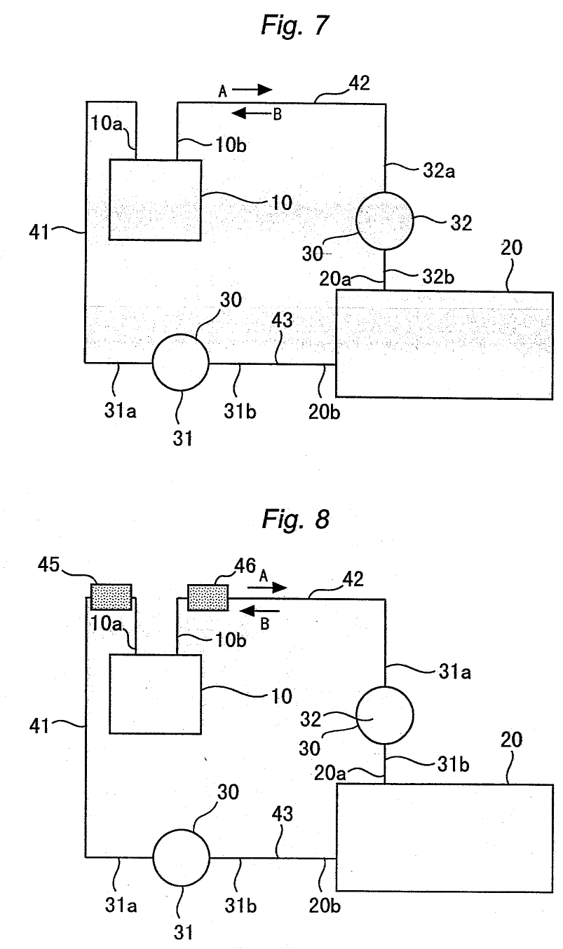

FIG. 7 is a view showing the overall configuration of a plating system according to a fourth embodiment of the present invention. The plating system according to the fourth embodiment is used for the plating method according to the present invention. Further, the plating system is employed in plating processes of the method of manufacturing a semiconductor device and in those of the method of manufacturing a printed board, both pertaining to the present invention. In the fourth embodiment, two pumps 31 and 32 are used as the pump 30 for supplying a plating fluid to the closed plating cup 10. Both the pumps 31 and 32 are of non-pulsating type. More specifically, the pumps 31 and 32 correspond to dubbed magnet pumps. The magnet pump rotates a rotor by the same principle as that by which a motor rotates, thereby applying pressure to a plating fluid so as to continuously squirt the plating fluid. In contrast to a pulsating pump, outlet ports 31a and 32a continuously squirt a plating fluid. Here, reference numeral 31b designates an inlet port of the pump 31, and 32b designates an inlet port of the pump 32.

The pumps 31 and 32 are connected so as to supply a plating fluid to the processing chamber 130 of the closed plating cup 10 in opposite directions. Specifically, the outlet port 31a of the pump 31 is connected to the plating fluid circulation port 10a by means of the pipe 41, and the outlet port 32a of the pump 32 is connected to the plating fluid circulation port 10b by means of the pipe 42. Consequently, when the pump 31 is actuated, the plating fluid is circulated through the processing chamber 130 in the direction designated by arrow A from the plating fluid circulation port 10a to the plating fluid circulation port 10b. Further, when the pump 32 is actuated, the plating fluid is circulated through the processing chamber 130 in the direction designated by arrow B from the plating fluid circulation port 10b to the plating fluid circulation port 10a.

The pumps 31 and 32 are actuated alternately and intermittently. When the pump 31 is actuated, the pump 32 remains inoperative. Similarly, when the pump 32 is actuated, the pump 31 remains inoperative. Consequently, the direction in which the plating fluid is circulated in the processing chamber 130 is cyclically reversed. Reversing the direction of circulation of the plating fluid results in varying the pressure and flow rate of a plating fluid which circulates while remaining in contact with the blind holes 53 of the member 50 and is effective for preventing occurrence of air bubbles in the blind holes 53 and air bubbles remaining in the same. Provided that one direction of circulation of a plating fluid is taken as positive, the direction of circulation of a plating fluid in the processing chamber 130 is switched such that the pressure and flow rate of the plating fluid vary greatly from a positive value to a negative value. Hence, switching of the direction of circulation of a plating fluid is effective for discharging air bubbles from the blind holes 53.

Fifth Embodiment

FIG. 8 is a view showing the overall configuration of a plating system according to a fifth embodiment of the present invention. The plating system according to the fifth embodiment is used for the plating method according to the present invention. Further, the plating system is employed in plating processes of the method of manufacturing a semiconductor device and in those of the method of manufacturing a printed board, both pertaining to the present invention. In the fifth embodiment, further improvements are made to the plating system according to the fifth embodiment shown in FIG. 7. Elements which are the same as those shown in FIG. 7 are assigned the same reference numerals. In the fifth embodiment, the plating fluid circulation port 10a of the closed plating cup 10 is equipped with a flow-rate control valve 45, and the plating fluid circulation port 10b is equipped with a flow-rate control valve 46. For instance, the flow-rate control valves 45 and 46 are electromagnetic control valves and can control a flow rate electrically. In synchronism with alternate actuation of the pumps 31 and 32, the flow-rate control valves 45 and 46 control a flow rate.

When the pump 31 is actuated, the flow-rate control valve 46 attached to the circulation port 10b is taken as a flow-rate throttle valve, thereby increasing the pressure of the plating fluid circulation port 10b by way of which a plating fluid is drained from the processing chamber 130. In contrast, when the pump 32 is actuated, the flow-rate control valve 45 attached to the circulation port 10a is taken as a flow-rate throttle valve, thereby increasing the pressure of the plating fluid circulation port 10b by way of which a plating fluid is drained from the processing chamber 130. The flow-rate control valves 44 and 45 facilitate adjustment of a plating fluid in the processing chamber 130 at a higher pressure. Air bubbles are effectively discharged from the blind holes 53 by means of switching the direction of circulation of the plating fluid.

Sixth Embodiment

A sixth embodiment relates to a chemical treatment system to be used in a residual elimination processing operation for eliminating residues from surfaces, including interior surfaces of via holes of a semiconductor device, in an electroless plating operation for forming an electroless-plated layer on the interior surfaces of via holes of the semiconductor device, and in an electroless plating operation for forming an electroless-plated layer on the interior surfaces of through holes of a printed board. The chemical treatment system according to the sixth embodiment is basically analogous to the plating system according to the first embodiment. By reference to FIGS. 1 through 3, there will be given an explanation of primarily a difference between the chemical treatment system and the plating system.

In brief, the chemical treatment system according to the sixth embodiment differs from the plating system shown in FIGS. 1 through 3 in that the plating fluid 60 is changed to a residue elimination fluid or an electroless plating fluid and that the member to be plated 50 is changed to a member to be subjected to treatment. In association with these changes, reference numerals 10a, 10b, 20a, and 20b designate treatment fluid flow ports; and 40 designates a treatment fluid circulation channel. For example, the member to be processed 50 is a semiconductor wafer or a printed board. The closed plating cup 10 is a closed-type treatment cup and is substantially identical in construction with that shown in FIGS. 1 through 3. In the sixth embodiment, neither the residue elimination treatment nor the electroless plating treatment require power feeding. Hence, the ring-shaped seal member 122 is removed, and the processing chamber 130 is sealed with only the auxiliary seal member 123. In association with removal of the seal member 122, the cathode contact 124 is also removed. Further, a mesh anode electrode 114 is also removed, or no d.c. voltage is supplied to the mesh anode electrode 114. In other respects, the chemical treatment system is identical in construction with that shown in FIGS. 1 through 3.

The chemical treatment system according to the sixth embodiment employs a pulsating pump as the pump 30 in the same manner as in the first embodiment. For instance, a bellows pump or a diaphragm pump is used. A treatment fluid 60 is delivered to the processing chamber 130 of the closed processing cup 10 by means of the pump. As a result of use of a pulsating pump, a pump pressure periodically changes in a pulse-like manner. A flow rate of the pump also changes periodically. The pressure and flow rate of the treatment fluid 60 are set to the same pressure and flow rate as those described in connection with the first embodiment. Periodic changes in the pressure and flow rate of the treatment fluid 60 prevent occurrence of buildup of air bubbles in a member to be treated; for example, at positions on a semiconductor wafer where via holes are formed or positions on a printed board where through holes are formed. Therefore, in the same manner as mentioned in connection with the first embodiment, there can be prevented occurrence of deficiencies in a residue elimination treatment or electroless plating treatment, which would otherwise be caused by buildup of air bubbles.

Seventh Embodiment

The method of eliminating residues through use of the chemical treatment system described in connection with the sixth embodiment will now be described as a seventh embodiment. The residue elimination treatment is performed during the course of the process for manufacturing a semiconductor device shown in FIGS. 5A through 5D. More specifically, the residue elimination treatment is to be effected after the etching process shown in FIG. 5B.

In the etching process shown in FIG. 5B, via holes 52 are formed in the semiconductor substrate 51 made of gallium arsenide, by means of, for example, plasma etching or RIE. When the etching process has been completed, residues, such as carbon or chlorine, remain on the interior surfaces of the via holes 52. The residue elimination treatment according to the seventh embodiment is for eliminating those residues. The residue elimination treatment is to be effected before formation of the closure member 55 following removal of the resist film 56. Alternatively, the residue elimination treatment may be effected for a blind hole 53 after formation of the closure member 55. Examples of the seventh embodiment will now be described.

### EXAMPLE 1

The first example of the seventh embodiment employs an S710 resist remover (manufactured by Tokyo Ohka Kogyo Ltd.) as a treatment fluid 60. The treatment fluid 60 contains orthodichlorobenzene, phenol, and alkyl benzene sulfonate. The treatment fluid 60 was circulated through the processing chamber 130 at the same pressure and flow rate as described in Paragraph 0064 and with the same bellows pump as described in Paragraph 0064, whereby residues were eliminated from a semiconductor substrate 51 placed faceup in the processing chamber 130. The fluid assumed a temperature of about 100° C. to 120° C. in the processing chamber 130, and the treatment time was set to 10 minutes. Consequently, deficiencies in residue elimination due to buildup of air bubbles are not found.

### EXAMPLE 2

In the second example of the seventh embodiment, an EKC256 resist remover (manufactured by EKC Corporation in the U.S.) was used as the treatment fluid 60. The treatment fluid contains ethanolamine as the main ingredient. The fluid assumed a temperature of about 85° C. in the processing chamber 130, and the treatment time was set to 10 minutes. In other respects, residues were eliminated under the same conditions as those employed in the first embodiment. Consequently, deficiencies in residue elimination due to buildup of air bubbles are not found.

Eighth Embodiment

A method for electroless deposition of a semiconductor device to be performed by the chemical treatment system described in connection with the sixth embodiment is described as an eighth embodiment of the present invention. Electroless deposition is performed according to the method of manufacturing a semiconductor device shown in FIGS. 5A through 5D. More specifically, electroless deposition is to be performed during the process of forming a feeding layer 54 shown in FIG. 5C.

More specifically, a process for forming the feeding layer 54 was performed while the via holes 52 were closed with the closure member 55 to constitute blind holes 53. The semiconductor substrate 51 was placed in the processing chamber 130 while remaining face-up. The treatment fluid 60 was circulated through the processing chamber 130 at the same pressure and flow rate as described in the first embodiment and with the same bellows pump as described in the first embodiment, whereby the semiconductor substrate was subjected to electrolytic plating. More specifically, the electroless plating to which a semiconductor device is to be subjected in connection with the eighth embodiment is performed by means of effecting, in the order given, three processes; that is, a palladium activation process, an electroless plating process, and a substitutional gold plating process.

During the palladium activation process, a palladium catalyst is imparted to the surface of the semiconductor substrate 51 to be plated and does not require use of the chemical treatment system described in connection with the sixth embodiment. More specifically, a palladium activator fluid containing palladium chloride (PdCl₂) as the main ingredient is placed into a predetermined container separate from the closed processing cup 10, and the semiconductor substrate 51 is immersed in the fluid.

During the subsequent electroless plating process, nickel-phosphorous (Ni-P), for example, is plated in a nonelectrolytic manner. More specifically, a mixture consisting of nickel sulfate (NiSO₄) and sodium hypophosphite (NaH₂P0₄) is heated up to 60 to 90° C. The semiconductor substrate 51 that has finished undergoing palladium activation treatment is immersed in the mixture, thereby forming an Ni—P plated layer to a thickness of 0.2 to 0.5 μm. During the electroless plating process, hydrogen gas develops, and the treatment fluid in the via holes 52 is agitated. Hence, there is no necessity of pulsating the fluid, and hence the electroless plating process is performed in a vessel differing from the closed processing cup 10.

Final substitutional gold plating process is carried out by use of a chemical processing system as described in the sixth embodiment. In the substitutional gold plating process, the surface of the Ni—P plated layer is substituted by gold. Example processes are given below.

### EXAMPLE 1

(1) Treatment fluids

Metal supply agent: gold cyanide potassium (several grams/liter)

Stabilizer: a chelating agent, a complexing agent (tens of grams/liter)

Additive: trace amounts

pH: 6 to 7

Temperature of fluids in the processing chamber 130: 80 to 90° C.

(2) Plating time: 5 to 10 minutes

(3) Thickness of substituted gold plating: 0.1 μm

(4) Pulsation of a treatment fluid: circulated at the same pressure and flow rate as described in Paragraph 0064 and with the same bellows pump as described in the same paragraph

(5) Plating deficiencies: None

### EXAMPLE 2

(1) Treatment fluids

Metal supply agent: gold sulfite (several grams/liter)

Stabilizer: a chelating agent, a complexing agent (tens of grams/liter)

Additive: trace amounts

pH: 7 to 8

Temperature of fluids in the processing chamber 130: 50 to 70° C.

(2) Plating time: 5 to 10 minutes

(3) Thickness of substituted gold plating: 0.1 μm

(4) Pulsation of a treatment fluid: circulated at the same pressure and flow rate as described in Paragraph 0064 and with the same bellows pump as described in the same paragraph

(5) Plating deficiencies: None

No planting deficiencies arose even in these examples. A conceivable reason for this is that air bubbles have not built up in blind holes, because of pulsation of the treatment fluid.

Ninth Embodiment

A ninth embodiment relates to a method of plating a printed board by means of an electroless plating method. Electroless plating for a printed board is effected, after forming through holes in the printed board, for forming an electroless plated layer on the interior surfaces of the respective through holes when the through holes are closed at one end thereof, to constitute blind holes.

In more detail, electroless plating of a printed board is effected in sequence of: an acid degreasing process, an acid activation process, a soft etching process, an acid activation process, a palladium activation process, an acid neutralization process, an electroless plating process, a substitutional gold plating process, and a thick gold plating process. During the acid degreasing process, the interior surfaces of the through holes are degreased. During the acid activation process, the interior surfaces of the through holes are subjected to acid activation. During the soft etching process, the interior surfaces of the through holes are roughened with an etchant. During the palladium activation process, a palladium catalyst is imparted to the interior surfaces of the through holes in the same manner as described in connection with the seventh embodiment. During the acid neutralization process, an acid is neutralized after activation of palladium. During the electroless plating process, an Ni—P plated layer is formed on the interior surfaces of the through holes in the same manner as described in connection with the seventh embodiment, by means of an electroless plating method. All these processes are performed without use of the chemical treatment system described in connection with the sixth embodiment.

Both the substitutional gold plating process and the thick gold plating process are carried out through use of the chemical treatment system described in connection with the sixth embodiment. The substitutional gold plating process is performed in the same manner as described in connection with the eighth embodiment. During the thick gold plating process, the thickness of plated gold is increased after gold has been deposited in the substitutional gold plating process. The thick gold plating process will now be described by reference to examples provided below.

### EXAMPLE 1

(1) Treatment fluids

Metal supply agent: gold cyanide potassium (several grams/liter)

Stabilizer: a chelating agent, a complexing agent (tens of grams/liter)

Reducer: several grams/liter

Additive: trace amounts

pH: 6 to 7

Temperature of fluids in the processing chamber 130: about 70° C.

(2) Plating time: 60 minutes

(3) Thickness of deposited gold plating: 0.1 μm

(4) Pulsation of a treatment fluid: circulated at the same pressure and flow rate as described in Paragraph 0064 and with the same bellows pump as described in the same paragraph

(5) Plating deficiencies: None

### EXAMPLE 2

(1) Treatment fluids

Metal supply agent: gold sulfite (several grams/liter)

Stabilizer: a chelating agent, a complexing agent (tens of grams/liter)

Reducer: several grams/liter

Additive: trace amounts p1 pH: 7 to 8

Temperature of fluids in the processing chamber 130: 50 to 70° C.

(2) Plating time: 60 minutes

(3) Thickness of deposited gold plating: 0.7 μm

(4) Pulsation of a treatment fluid: circulated at the same pressure and flow rate as described in Paragraph 0064 and with the same bellows pump as described in the same paragraph

(5) Plating deficiencies: None

No planting deficiencies arose in any of the examples. A conceivable reason for this is that air bubbles have not built up in blind holes, because of pulsation of the treatment fluid.

Tenth Embodiment

A tenth embodiment relates to a method of plating through holes of a printed board, by means of an electroless copper plating method. In more detail, electroless copper plating of a printed board is effected in sequence of: an acid degreasing process, an acid activation process, a soft etching process, an acid activation process, a palladium activation process, an acid neutralization process, and an electroless plating process. During the acid degreasing process, the interior surfaces of the through holes are degreased. During the acid activation process, the interior surfaces of the through holes are subjected to acid activation. During the soft etching process, the interior surfaces of the through holes are roughened with an etchant. During the palladium activation process, a palladium catalyst is imparted to the interior surfaces of the through holes in the same manner as described in connection with the seventh embodiment. All these processes are performed without use of the chemical treatment system described in connection with the sixth embodiment.

During the electroless copper plating process, a Cu plated layer is formed on the interior surfaces of the through holes by means of an electroless plating method. The process is performed through use of the chemical treatment system described in connection with the sixth embodiment. The electroless copper plating method will be described by reference to the examples provided below.

### EXAMPLE 1

(1) Treatment fluids

Metal supply agent: copper sulfate (about 10 grams/liter)

Stabilizer: EDTA (about 30 grams/liter)

Reducer: formaldehyde (several milligrams/liter)

Additive: 2,2, dipyridyl (several PPM)

Additive: surfactant

pH: about 12

Temperature of fluids in the processing chamber 130: 70° C.

(2) Plating rate: 1 to 3 microns/hour

(3) Pulsation of a treatment fluid: circulated at the same pressure and flow rate as described in Paragraph 0064 and with the same bellows pump as described in the same paragraph

(4) Plating deficiencies: None

No planting deficiencies arose even in this example. A conceivable reason for this is that air bubbles have not built up in blind holes, because of pulsation of the treatment fluid.

Other Embodiments

Any of the plating system shown in FIG. 6 that has been described in connection with the third embodiment, the plating system shown in FIG. 7 that has been described in connection with the fourth embodiment, and the plating system shown in FIG. 8 that has been described in connection with the fifth embodiment can be used as the chemical treatment system to be used for subjecting a semiconductor device to residue elimination treatment and electroless plating treatment and used for subjecting a printed board to electroless plating.

In brief, in relation to the plating systems shown in FIGS. 6 through 8, the plating fluid 60 is changed to a residue elimination treatment fluid or an electroless plating fluid; and the member to be plated 50 is changed to a member to be treated. In association with these changes, reference numerals 10a, 10b, 20a, and 20b designate treatment fluid flow ports; and 40 designates a treatment fluid circulation channel. The member to be processed 50 is a semiconductor wafer or a printed board. The closed plating cup 10 is a closed-type treatment cup and is substantially identical in construction with that shown in FIGS. 1 through 3. In the sixth embodiment, neither the residue elimination treatment nor the electroless plating treatment require power feeding. Hence, the ring-shaped seal member 122 is removed, and the processing chamber 130 is sealed with only the auxiliary seal member 123. In association with removal of the seal member 122, the cathode contact 124 is also removed. Further, the mesh anode electrode 114 is also removed, or no d.c. voltage is supplied to the mesh anode electrode 114. In other respects, the chemical treatment system is identical in construction with that shown in FIGS. 1 through 3.

A chemical treatment system based on the plating system shown in FIG. 6 is effective for closely regulating the pressure of the treatment fluid in the processing chamber 130 with the flow throttle valve 44 and has the effect of hindering occurrence of treatment failures, which would otherwise be caused by an air trap. In a chemical treatment system based on the plating system shown in FIG. 7, the pumps 31, 32 are intermittently and alternately actuated. As a result, the direction in which the treatment fluid flows in the processing chamber 130 is periodically reversed. The pressure and flow rate of the treatment fluid that flows while remaining in contact with the blind holes are periodically reversed, thereby eliminating occurrence and buildup of air bubbles in the blind holes. In a chemical treatment system based on the plating system shown in FIG. 8, when the pump 31 is actuated, the flow regulation valve 46 acts as a flow throttle valve. Further, when the pump 32 is actuated, the flow regulation valve 45 acts as a flow throttle valve. As a result of an increase in the pressure of the treatment fluid flow port 10a and an increase in that of the treatment fluid flow port 10b, both discharging a treatment fluid, the pressure of the treatment fluid in the processing chamber 130 can be regulated readily. Switching of the flowing direction of the treatment fluid and effective discharge of air bubbles from the blind holes can be effected.

As is evident from the foregoing descriptions, the plating systems shown in FIGS. 1 through 3 can be used for electrolytic plating, and the plating systems shown in FIGS. 6 through 8 can be used for electroless plating. Electrolytic plating is effected in the method of manufacturing a semiconductor device, and electroless plating is effected in the method of manufacturing a printed board. When the plating system is used for electroless plating, the power feeding mechanism to be provided in the closed processing cup becomes unnecessary and can be eliminated. The plating systems shown in FIGS. 1 through 3 and those shown in FIGS. 6 through 8 are used for eliminating residues in the process of manufacturing a semiconductor device. Even in the residue elimination process, the power feeding mechanism to be provided in the closed processing cup is unnecessary and can be eliminated.

The appended claims of this application are directed to a chemical processing system for processing a member through use of a closed-type processing cup. However, the present invention includes a plating system, a method of residual elimination, a method for chemical processing or a method for plating a member through use of a chemical processing system or a plating system using a closed-type processing cup or a plating cup as follows.

According to one aspect of the present invention, a plating system comprises: a closed plating cup which plates a member to be plated by means of circulating a plating fluid in the cup at a certain pressure and flow rate; a reservoir tank for storing the plating fluid; and a pump for supplying the plating fluid from the reservoir tank to the closed plating cup, wherein the pump cyclically changes at least the pressure or flow rate of the plating fluid in the closed plating cup. (#12)

In another aspect, in the plating system, the pump is constituted of a pulsating pump, and the pulsating pump cyclically changes at least either the pressure or flow rate of the plating fluid circulating within the closed plating cup. (#13)

In another aspect, in the plating system, the pulsating pump is constituted of a bellows pump, and the bellows pump cyclically pulsates the bellows, to thereby supply the plating fluid to the closed plating cup and to cyclically change at least either the pressure or flow rate of the plating fluid circulating within the closed plating cup. (#14)

In another aspect, in the plating system, the pulsating pump is constituted of a diaphragm pump, and the diaphragm of the diaphragm pump is cyclically pulsated, to thereby supply the plating fluid to the closed plating cup and to cyclically change at least either the pressure or flow rate of the plating fluid circulating within the closed plating cup. (#15)

In another aspect, the plating system further comprises a supply channel for supplying the plating fluid to the closed plating cup, a drain channel for discharging the plating fluid from the closed plating cup, and a flow-rate throttle valve provided in the drain channel for discharging the plating fluid. (#16)

According to one aspect of the present invention, a plating system comprises a closed plating cup which plates a member to be plated by means of circulating a plating fluid in the cup at a certain pressure and flow rate; a reservoir tank for storing the plating fluid; and a pump for supplying the plating fluid from the reservoir tank to the closed plating cup, wherein the direction of circulation of the plating fluid in the closed plating cup is cyclically changed. (#17)

In another aspect, in the plating system, the closed plating cup has first and second plating circulation ports; the pump comprises first and second pumps; the first pump circulates a plating fluid within the closed plating cup from the first plating fluid circulation port to the second plating fluid circulation port; and the second pump circulates the plating fluid from the second plating fluid circulation port to the first plating fluid circulation port. (#18)

In another aspect, the plating system further comprises a first plating fluid circulation channel communicating with the first plating fluid circulation port of the closed plating cup; a second plating fluid circulation channel communicating with the second plating fluid circulation port of the closed plating cup; a first flow-rate control valve provided in the first plating fluid circulation channel; and a second flow-rate control valve provided in the second plating fluid circulation channel, wherein, when the plating fluid flows from the first plating fluid circulation port to the second plating fluid circulation port, the second flow-rate control valve provided in the second plating fluid circulation channel communicates with the second plating fluid circulation port; and, when the plating fluid flows from the second plating fluid circulation port to the first plating fluid circulation port, the first flow-rate control valve provided in the first plating fluid circulation channel communicates with the first plating fluid circulation port. (#19)

In another aspect, in the plating system, the member to be plated has a plurality of blind holes, openings on one side of the blind holes being opened and openings on the other side of the same being closed, and is disposed in the closed plating cup such that the opened openings of the blind holes are in contact with the circulating plating fluid, and the surface of the member, including interior surfaces of the blind holes, is plated. (#20)

In another aspect, in the plating system, the member to be plated is a semiconductor wafer; the semiconductor wafer has a plurality of via holes, openings on one side of the via holes being opened and openings on the other side of the same being closed; the member is disposed in the closed plating cup such that the opened openings of the via holes are in contact with the circulating plating fluid, and the surface of the member, including interior surfaces of the via holes, is plated. (#21)

In another aspect, in the plating system, the member to be plated is a printed board; the semiconductor wafer has a plurality of through holes, openings on one side of the through holes being opened and openings on the other side of the same being closed; the member is disposed in the closed plating cup such that the opened openings of the through holes are in contact with the circulating plating fluid, and the surface of the member, including interior surfaces of the through holes, is plated. (#22)

According to another aspect of the present invention, there is provided a chemical treatment method of subjecting a surface of a member having a plurality of blind holes to chemical treatment, the surface including interior surfaces of the blind holes, and the blind holes being closed at one end and open at the other end. The method comprises: circulating a treatment fluid in a closed plating cup at a certain pressure and flow rate; placing the member to be treated in the closed processing cup such that openings of the respective blind holes at one end thereof remain in contact with the treatment fluid; and periodically switching at least either pressure or flow rate of the treatment fluid circulating within the closed processing cup. (#23)

According to another aspect of the present invention, there is provided a chemical treatment method of subjecting a surface of a member having a plurality of blind holes to chemical treatment, the surface including interior surfaces of the blind holes, and the blind holes being closed at one end and open at the other end. The method comprises: circulating a treatment fluid in a closed processing cup at a certain pressure and flow rate; placing the member to be treated in the closed processing cup such that openings of the respective blind holes at one end thereof remain in contact with the treatment fluid; and periodically switching a flowing direction of the treatment fluid circulating in the closed processing cup. (#24)

According to another aspect of the present invention, there is provided a method of manufacturing a semiconductor device having via holes penetrating through a semiconductor substrate, including a chemical treatment process for subjecting, to chemical treatment, a surface of the semiconductor substrate, including interior surfaces of the via holes. The chemical treatment process involves: circulating a treatment fluid in a closed processing cup at a certain pressure and flow rate; placing a semiconductor wafer including the semiconductor substrate in the closed processing cup such that openings of the respective via holes at one end thereof remain in contact with the treatment fluid while the other ends of the via holes are closed; and periodically switching at least either the pressure or flow rate of the treatment fluid circulating within the closed processing cup. (#25)

According to another aspect of the present invention, there is provided a method of manufacturing a semiconductor device having via holes penetrating through a semiconductor substrate, including a chemical treatment process for subjecting, to chemical treatment, a surface of the semiconductor substrate, including interior surfaces of the via holes. The chemical treatment process involves: circulating a treatment fluid in a closed processing cup at a certain pressure and flow rate; placing a semiconductor wafer including the semiconductor substrate in the closed processing cup such that openings of the respective via holes at one end thereof remain in contact with the treatment fluid while the other ends of the via holes are closed; and periodically switching a flowing direction of the treatment fluid circulating within the closed processing cup. (#26)

According to another aspect of the present invention, there is provided a method of manufacturing a printed board having through holes penetrating through a substrate, including a chemical treatment process for subjecting, to chemical treatment, a surface of the substrate, including interior surfaces of the via holes. The chemical treatment process involves:

circulating a treatment fluid within a closed processing cup at a certain pressure and flow rate; placing a semiconductor wafer including the semiconductor substrate in the closed processing cup such that openings of the respective through holes at one end thereof remain in contact with the treatment fluid while the other ends of the via holes are closed; and periodically switching at least either the pressure or flow rate of the treatment fluid circulating in the closed processing cup. (#27)

According to another aspect of the present invention, there is provided a method of manufacturing a printed board having through holes penetrating through a substrate, including a chemical treatment process for subjecting, to chemical treatment, a surface of the substrate, including interior surfaces of the via holes. The chemical treatment process involves: circulating a treatment fluid in a closed processing cup at a certain pressure and flow rate; placing a semiconductor wafer including the semiconductor substrate in the closed processing cup such that openings of the respective through holes at one end thereof remain in contact with the treatment fluid while the other ends of the through holes are closed; and periodically switching a flowing direction of the treatment fluid circulating in the closed processing cup. (#28)

According to another aspect of the present invention, in a plating method under which a member to be plated having a plurality of blind holes, openings on one side of the blind holes being opened and openings on the other side of the same being closed, is plated such that the surface of the member, including interior surfaces of the respective blind holes, is plated, wherein the member is disposed in the closed plating cup such that openings on one side of the respective blind holes are in contact with a plating fluid by means of circulating the plating fluid within the closed plating cup at a certain pressure and flow rate, and at least either the pressure or flow rate of the plating fluid circulating within the closed plating cup is changed cyclically. (#29)

According to another aspect of the present invention, in a plating method under which a member to be plated having a plurality of blind holes, openings on one side of the blind holes being opened and openings on the other side of the same being closed, is plated such that the surface of the member, including interior surfaces of the respective blind holes, is plated, wherein the member is disposed in the closed plating cup such that openings on one side of the respective blind holes are in contact with a plating fluid by means of circulating the plating fluid within the closed plating cup at a certain pressure and flow rate, and the direction of circulation of the plating fluid circulating through the closed plating cup is changed cyclically. (#30)

According to another aspect of the present invention, there is provided a method of manufacturing a semiconductor device having via holes penetrating through a semiconductor substrate. The method comprises: a plating step of plating the surface of the semiconductor substrate, including interior surfaces of the via holes, wherein the plating step involves circulation of a plating fluid within a closed plating cup at a certain pressure and flow rate, disposition of the semiconductor wafer including the semiconductor substrate in the closed plating cup such that openings on one side of the via holes are opened and openings on the other side of the via holes are closed and such that the opened openings are in contact with the plating fluid, and cyclic change in at least the pressure or flow rate of the plating fluid circulating within the closed plating cup. (#31)

According to another aspect of the present invention, there is provided a method of manufacturing a semiconductor device having via holes penetrating through a semiconductor substrate. The method comprises: a plating step of plating the surface of the semiconductor substrate, including interior surfaces of the via holes, wherein the plating step involves circulation of a plating fluid within a closed plating cup at a certain pressure and flow rate, disposition of the semiconductor wafer including the semiconductor substrate in the closed plating cup such that openings on one side of the via holes are opened and openings on the other side of the via holes are closed and such that the opened openings are in contact with the plating fluid, and cyclic change in the direction of circulation of the plating fluid circulating within the closed plating cup. (#32)

According to another aspect of the present invention, there is provided a method of manufacturing a printed board having through holes penetrating through a board. The method comprises: a plating step of plating the surface of the board, including interior surfaces of the through holes, wherein the plating step involves circulation of a plating fluid within a closed plating cup at a certain pressure and flow rate, disposition of the board in the closed plating cup such that openings on one side of the through holes are opened and openings on the other side of the through holes are closed and such that the opened openings are in contact with the plating fluid, and cyclic change in at least the pressure or flow rate of the plating fluid circulating within the closed plating cup. (#33)

According to another aspect of the present invention, there is provided a method of manufacturing a printed board having through holes penetrating through a board. The method comprises: a plating step of plating the surface of the board, including interior surfaces of the through holes, wherein the plating step involves circulation of a plating fluid within a closed plating cup at a certain pressure and flow rate, disposition of the board in the closed plating cup such that openings on one side of the through holes are opened and openings on the other side of the through holes are closed and such that the opened openings are in contact with the plating fluid, and cyclic change in the direction of circulation of the plating fluid circulating within the closed plating cup. (#34)

According to another aspect of the present invention, there is provided a residue elimination method for subjecting a surface of a member to be treated, including interior surfaces of blind holes, to residue elimination processing, the blind holes being closed at one end and open at the other end. The method includes: circulating a treatment fluid in a closed processing cup at a certain pressure and flow rate; placing the member the closed processing cup such that openings of the respective blind holes at one end thereof remain in contact with the treatment fluid while the other ends of the blind holes are closed; and periodically switching at least the pressure or flow rate of the treatment fluid circulating within the closed processing cup. (#35)

According to another aspect of the present invention, there is provided a residue elimination method for subjecting a surface of a member to be treated, including interior surfaces of blind holes, to residue elimination processing, the blind holes being closed at one end and open at the other end. The method includes: circulating a treatment fluid within a closed processing cup at a certain pressure and flow rate; placing the member the closed processing cup such that openings of the respective blind holes at one end thereof remain in contact with the treatment fluid while the other ends of the blind holes are closed; and periodically switching the flowing direction of the treatment fluid circulating within the closed processing cup. (#36)

According to another aspect of the present invention, there is provided a method of manufacturing a semiconductor device having via holes penetrating through a semiconductor substrate, including a residue elimination process for subjecting, to residue elimination treatment, a surface of the semiconductor substrate, including interior surfaces of the via holes. The chemical treatment process involves: circulating a treatment fluid in a closed processing cup at a certain pressure and flow rate; placing a semiconductor wafer including the semiconductor substrate in the closed processing cup such that openings of the respective via holes at one end thereof remain in contact with the treatment fluid while the other ends of the via holes are closed; and periodically switching at least either the pressure or flow rate of the treatment fluid circulating in the closed processing cup. (#37)

According to another aspect of the present invention, there is provided a method of manufacturing a semiconductor device having via holes penetrating through a semiconductor substrate, including a residue elimination process for subjecting, to residue elimination treatment, a surface of the semiconductor substrate, including interior surfaces of the via holes. The chemical treatment process involves: circulating a treatment fluid in a closed processing cup at a certain pressure and flow rate; placing a semiconductor wafer including the semiconductor substrate in the closed processing cup such that openings of the respective via holes at one end thereof remain in contact with the treatment fluid while the other ends of the via holes are closed; and periodically switching a flowing direction of the treatment fluid circulating within the closed processing cup. (#38)

The features and advantages of the present invention as described above may be summarized as follows.

As has been described, according to one aspect of the present invention, the chemical treatment system has the closed processing cup which subjects a member to be treated to chemical treatment while circulating therein a treatment fluid at a certain pressure and a certain flow rate. The pump for supplying a treatment fluid to the closed processing cup periodically changes at least either the pressure or flow rate of the treatment fluid in the closed processing cup. As a result, there is yielded an effect of diminishing air bubbles remaining in the member to be treated and lessening treatment failures that occur as a result of buildup of air bubbles.

In another aspect, the pump is preferably constituted of a pulsating pump, and the pulsating pump is further constructed of a bellows pump or a diaphragm pump. The pump supplies a treatment fluid to the closed processing cup by means of pulsating action of the pump. In a case where at least either the pressure or flow rate of a treatment fluid circulating through the closed processing cup is changed periodically, at least either the pressure or flow rate of the treatment fluid circulating through the closed processing cup by means of the pulsating pump is effectively changed. There is yielded an effect of diminishing the amount of air bubbles captured by a member to be treated and lessening treatment failures that occur as a result of buildup of air bubbles.

In another aspect, in a chemical treatment system having a flow throttle valve provided in a channel for discharging a treatment fluid to the closed processing cup, the pressure of a treatment fluid in the closed processing cup can be regulated closely. Further, at least either the pressure or flow rate of the treatment fluid is periodically changed. As a result, there is effected an advantage of effectively reducing air bubbles remaining in the member to be treated and lessening treatment failures that occur as a result of buildup of air bubbles.

In another aspect, in a chemical treatment system which periodically changes the direction in which the treatment fluid flows in the closed processing cup, the flow rate of the treatment fluid as well as the direction thereof is changed drastically. As a result, there is effected an advantage of effectively reducing air bubbles remaining in the member to be treated and lessening treatment failures that occur as a result of buildup of air bubbles.

In another aspect, in a chemical treatment system, which uses two pumps to periodically change the direction of the treatment fluid flows in the closed processing cup, the circulating direction of the treatment fluid can be changed effectively. A chemical treatment system is provided with a flow regulation valve disposed in a channel for circulating a treatment fluid to the closed processing cup. By means of switching between two pumps, a flow regulation valve provided in the treatment fluid discharge channel is caused to act as a flow throttle valve. In such a chemical treatment system, the pressure of a treatment fluid in the closed processing cup can be regulated closely. Further, at least either the pressure or flow rate of the treatment fluid is periodically changed. As a result, there is effected an advantage of effectively reducing air bubbles remaining in the member to be treated and lessening treatment failures that occur as a result of buildup of air bubbles.

In another aspect, a member to be treated may have a plurality of blind holes, and the member is disposed in the closed processing cup such that openings of the blind holes remain in contact with a treatment fluid, thereby subjecting a surface, including interior surfaces of the blind holes, to treatment. In this case, occurrence of buildup of air bubbles in blind holes can be prevented effectively, thereby diminishing treatment failures that occur as a result of buildup of air bubbles. Further, a semiconductor wafer, in which openings of the via holes on one side thereof are closed, or a printed board, in which openings of through holes on one side thereof are closed, is subjected to treatment in the same manner. Similarly, buildup of air bubbles in the via holes or through holes is reduced, and treatment failures that occur as a result of buildup of air bubbles can be diminished.

Next, according to another aspect of the present invention, the plating system may by used in an electro plating and electroless plating operation, and has the closed plating cup which plates a member to be plated by means of circulating a plating fluid in the plating system at a certain pressure and flow rate. The pump for supplying a plating fluid to the closed plating cup cyclically changes at least either a pressure or flow rate of a plating fluid in the closed plating cup. Hence, the plating system yields an advantage of the ability to lessen the likelihood of air bubbles remaining on the member and the likelihood of plating failures ascribable to air bubbles that remain.

In another aspect, the pump is constituted of a pulsating pump, and the pulsating pump is constituted of a bellows pump or a diaphragm pump. A plating fluid is supplied to the closed plating cup by means of pulsating action of the pump, thereby cyclically changing at least either a pressure or flow rate of the plating fluid circulating through the inside of the closed plating cup. At least either a pressure of flow rate of the plating fluid circulating through the inside of the closed plating cup is effectively changed by means of the pulsating pump. Hence, there is yielded an advantage of the ability to lessen the amount of air bubbles remaining on a member to be plated and the likelihood of plating failures ascribable to air bubbles that remain.

In another aspect, in the case of the plating system equipped with a flow-rate throttle valve attached to a channel by way of which a plating fluid is discharged from the closed plating cup, the pressure of a plating fluid circulating through the inside of the closed plating cup can be adjusted at a higher level. There is yielded an advantage of the ability to effectively lessen the amount of air bubbles that remain on the member and the likelihood of air bubbles remaining, by means of cyclic changes in at least either a pressure or flow rate of a plating fluid.

In another aspect, when the direction of circulation of a plating fluid circulating through the inside of the closed plating cup is cyclically changed, the flow rate of the plating fluid as well as the direction of the same is changed greatly. Hence, there is yielded an advantage of the ability to effectively lessen the amount of air bubbles that remain on the member and the likelihood of plating failures ascribable to air bubbles that remain.

In another aspect, when the direction of circulation of a plating fluid in the closed plating cup is cyclically changed through use of two pumps, the direction of circulation of a plating fluid can be changed effectively. A flow-rate control valve is provided in each of the plating fluid circulation channels of the closed cup plating cup. In association with switching between the two pumps, the flow-rate control valve connected to a channel by way of which a plating fluid is to be discharged is taken as a flow-rate throttle valve. As a result, the pressure of a plating fluid in the closed plating cup can be adjusted at a higher level. There is yielded an advantage of the ability to effectively lessen the amount of air bubbles that remain on the member, by means of cyclic changes in at least either the pressure or flow rate of a plating fluid, thereby diminishing the likelihood of plating failures ascribable to air bubbles that remain.

In another aspect, the member to be plated has a plurality of blind holes and is disposed in the closed plating cup such that openings of the blind holes remain in contact with a plating fluid. A plating layer is formed on the surface of the member, including interior surfaces of the blind holes. As a result, air bubbles that remain in the blind holes are effectively prevented, thereby lessening the likelihood of plating failures ascribable to air bubbles that remain. A plating layer is formed on a semiconductor wafer having via holes, the via holes being closed at one end thereof, or on a printed board having via holes, the via holes being closed at one end thereof. Similarly, the amount of air bubbles that remain in via holes or through holes is diminished, thereby lessening the likelihood of plating failures ascribable to air bubbles that remain.

Next, according to another aspect of the present invention, the chemical treatment method is a method of subjecting, to chemical treatment, a member which is to be subjected to treatment and has a plurality of blind holes. The method includes placing of the member in a closed processing cup such that openings of the blind holes on one side thereof remain in contact with a treatment fluid, and periodic changing of at least either the pressure or flow rate of a treatment fluid in the closed processing cup. There is an advantage of reducing the amount of air bubbles that are built up in the member to be processed and to diminish treatment failures that occur as a result of buildup of air bubbles.

[B 0114]

In another aspect, the chemical treatment method including periodic switching of the direction in which a treatment fluid flows through the inside of the closed processing cup yields the effect of reducing treatment failures that occur as a result of buildup of air bubbles, by means of drastically changing the flow rate of a treatment fluid as well as a flowing direction thereof and diminishing the amount of air bubbles that build up in a member to be treated.

Next, according to another aspect of the present invention, the method of manufacturing a semiconductor device includes a treatment process for subjecting a surface, including interior surfaces of a plurality of via holes, to chemical treatment. The treatment process includes placing of the member in a closed processing cup such that openings of the via holes on one side thereof remain in contact with a treatment fluid, and periodic changing of at least either the pressure or flow rate of the treatment fluid in the closed processing cup. The amount of air bubbles that build up in the member to be subjected to treatment is reduced, and treatment failures that occur as a result of buildup of air bubbles can be diminished. Further, under the method including periodic changing of the flowing direction of the treatment fluid in the closed processing cup, the flowing direction of the treatment fluid as well as the flow rate thereof are changed drastically, thereby effectively reducing the amount of air bubbles that build up in the blind holes and diminishing treatment failures that occur as a result of buildup of air bubbles. The performance of a semiconductor device and a manufacturing yield can be improved.

Next, according to another aspect of the present invention, the method of manufacturing a printed board includes a treatment process for subjecting a surface, including interior surfaces of a plurality of through holes, to chemical treatment. The treatment process includes placing of the member in a closed processing cup such that openings of the through holes on one side thereof remain in contact with a treatment fluid, and periodic changing of at least either the pressure or flow rate of the treatment fluid in the closed processing cup. The amount of air bubbles that build up in the member to be subjected to treatment is reduced, and treatment failures that occur as a result of buildup of air bubbles can be diminished. Further, under the method including periodic changing of the flowing direction of the treatment fluid in the closed processing cup, the flowing direction of the treatment fluid as well as the flow rate thereof are changed drastically, thereby effectively reducing the amount of air bubbles that build up in the through holes and diminishing treatment failures that occur as a result of buildup of air bubbles. Thereby, the performance of a printed board and a manufacturing yield can be improved.

Next, according to another aspect of the present invention, the plating method may be adopted in an electro plating and an electroless plating operation, and is for plating a member to be plated having a plurality of blind holes. The member is disposed in the closed plating cup such that openings of the blind holes remain in contact with a plating fluid. The method involves cyclic changes in at least either the pressure or flow rate of a plating fluid in the closed plating cup. There is yielded an advantage of the ability to lessen air bubbles that remain on the member, thereby diminishing the likelihood of plating failures ascribable to air bubbles that remain.

In another aspect, the plating method including cyclic switching of the direction of circulation of a plating fluid within a closed plating cup yields an advantage of the ability to greatly change the flow rate of a plating fluid as well as the direction of circulation of the same, thereby effectively diminishing the amount of air bubbles that remain on the member and lessening the likelihood of plating failures ascribable to air bubbles that remain.

Next, according to another aspect of the present invention, the method of manufacturing a semiconductor device includes a plating step of forming a plating layer on the surface of the member, including interior surfaces of a plurality of via holes. The plating step includes disposition of the member in the closed plating cup such that openings on one side of respective via holes are in contact with a plating fluid, and cyclic changes in at least either the pressure or flow rate of a plating fluid in the closed plating cup. The plating method diminishes the amount of air bubbles that remain on the member, thereby lessening the likelihood of plating failures ascribable to air bubbles that remain. Further, the plating method involving cyclic changes in the direction of circulation of a plating fluid in the closed plating cup enables a great change in the flow rate of a plating fluid as well as in the direction of circulation of the same, thereby effectively diminishing the amount of air bubbles that remain on the member and lessening the likelihood of plating failures ascribable to air bubbles that remain. Further, the method enables improvements in the performance of a semiconductor device as well as in manufacturing yield of the same.

Next, according to another aspect of the present invention, the method of manufacturing a printed board includes a plating step of forming a plating layer on the surface of the board, including interior surfaces of a plurality of via holes. The plating step includes disposition of the board in the closed plating cup such that openings on one side of respective through holes are in contact with a plating fluid, and cyclic changes in at least either the pressure or flow rate of a plating fluid in the closed plating cup. The plating method diminishes the amount of air bubbles that remain on the member, thereby lessening the likelihood of plating failures ascribable to air bubbles that remain. Further, the plating method involving cyclic changes in the direction of circulation of a plating fluid in the closed plating cup enables a great change in the flow rate of a plating fluid as well as in the direction of circulation of the same, thereby effectively diminishing the amount of air bubbles that remain on the member and lessening the likelihood of plating failures ascribable to air bubbles that remain. Further, the method enables improvements in the performance of a printed board as well as in manufacturing yield of the same.

Next, according to another aspect of the present invention, the residue elimination method is for eliminating residues from a member to be treated having a plurality of blind holes. The method includes placing of the member in a closed processing cup such that openings of the blind holes remain in contact with a treatment fluid, and periodic changing of at least either the pressure or flow rate of the treatment fluid in the closed processing cup. There is yielded an advantage of reducing the amount of air bubbles that build up in the member to be treated and diminishing treatment failures that occur as a result of buildup of air bubbles.

In another aspect, under the residue elimination method including periodic changing of the flowing direction of the treatment fluid in the closed processing cup, the flowing direction of the treatment fluid as well as the flow rate thereof are changed drastically, thereby yielding an advantage of effectively reducing the amount of air bubbles that build up in the blind holes and diminishing treatment failures that occur as a result of buildup of air bubbles.

Next, according to another aspect of the present invention, the method of manufacturing a semiconductor device includes a residue elimination process for subjecting a surface, including interior surfaces of a plurality of via holes, to residue elimination treatment. The residue elimination treatment process includes placing of the member in a closed processing cup such that openings of the via holes on one side thereof remain in contact with a treatment fluid, and periodic changing of at least either the pressure or flow rate of the treatment fluid in the closed processing cup. The amount of air bubbles that build up in the member to be subjected to treatment is reduced, and treatment failures that occur as a result of buildup of air bubbles can be diminished. Further, under the method including periodic changing of the flowing direction of the treatment fluid within the closed processing cup, the flowing direction of the treatment fluid as well as the flow rate thereof are changed drastically, thereby effectively reducing the amount of air bubbles that build up in the via holes and diminishing treatment failures that occur as a result of buildup of air bubbles. Thereby, the performance of a semiconductor device and a manufacturing yield can be improved.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-103431, filed on Apr. 2, 2001 and a Japanese Patent Application No. 2001-363086, filed on Nov. 28, 2001 including specifications, claims, drawings and summaries, on which the Convention priority of the present application is based, are incorporated herein by reference in its entirety.

What is claimed is:

1. A chemical treatment system comprising:
a closed processing cup which subjects a member to be treated to chemical treatment while circulating therein a treatment fluid at a certain pressure and a certain flow rate;
a fluid reservoir tank for storing the treatment fluid; and
a pump for supplying the treatment fluid from the fluid reservoir tank to the closed processing cup, wherein
the pump periodically changes at least either the pressure or flow rate of the treatment fluid in the closed processing cup.

2. The chemical treatment system according to claim 1, wherein the pump is constituted of a pulsating pump, and the pulsating pump periodically changes at least either the pressure or flow rate of the treatment fluid in the closed processing cup.

3. The chemical treatment system according to claim 2, wherein the pulsating pump is constructed of a bellows pump and the bellows pump periodically pulsates a bellows, to thereby supply the treatment fluid to the closed processing cup, thus periodically changing at least either the pressure or flow rate of the treatment fluid circulating through the closed processing cup.

4. The chemical treatment system according to claim 2, wherein the pulsating pump is constructed of a diaphragm pump, and the diaphragm pump periodically pulsates a diaphragm, to thereby supply the treatment fluid to the closed processing cup, thus periodically changing at least either the pressure or flow rate of the treatment fluid circulating through the closed processing cup.

5. The chemical treatment system according to claim 1, further comprising: a supply channel for supplying the treatment fluid to the closed processing cup, a discharge channel for discharging the treatment fluid from the closed processing cup, and a flow throttle valve provided in the discharge channel.

6. A chemical treatment system comprising:
a closed processing cup which subjects a member to be treated to chemical treatment while circulating therein a treatment fluid at a certain pressure and a certain flow rate;
a fluid reservoir tank for storing the treatment fluid; and
a pumping apparatus for supplying the treatment fluid from the fluid reservoir tank to the closed processing cup, wherein
the flowing direction of the treatment fluid within the closed processing cup is periodically changed.

7. The chemical treatment system according to claim 6, wherein the closed processing cup has first and second treatment fluid flow ports, and the pumping apparatus has first and second pumps; and wherein the first pump circulates the treatment fluid in the closed processing cup from the first treatment fluid flow port to the second treatment fluid flow port, and the second pump circulates the treatment fluid in the closed processing cup from the second treatment fluid flow port to the first treatment fluid flow port.

8. The chemical treatment system according to claim 7, further comprising:
a first treatment fluid channel to be connected to the first treatment fluid flow port of the closed processing cup;
a second treatment fluid channel to be connected to the second treatment fluid flow port of the closed processing cup;
a first flow regulation valve provided in the first treatment fluid flow channel; and
a second flow regulation valve provided in the second treatment fluid flow channel,
wherein, when the treatment fluid flows from the first treatment fluid flow port to the second treatment fluid flow port in the closed processing cup, the second flow regulation valve provided in the second treatment fluid flow channel connected to the second treatment fluid flow port is taken as a flow throttle valve; and wherein, when the treatment fluid flows from the second treatment fluid flow port to the first treatment fluid flow port, the first flow regulation valve provided in the first treatment fluid flow channel connected to the first treatment fluid flow port is taken as a flow throttle valve.

9. The chemical treatment system according to claim 1, wherein the member to be treated has a plurality of blind holes which are closed at one end and open at the other end, and a surface of the member, including interior surfaces of the blind holes, is subjected to chemical treatment while the member is placed in the closed processing cup such that openings of the blind holes remain in contact with the circulating treatment fluid.

10. The chemical treatment system according to claim 1, wherein the member to be subjected to treatment is a semiconductor wafer; the semiconductor wafer has a plurality of via holes which are closed at one end and open at the other end; and a surface of the semiconductor wafer, including interior surfaces of the via holes, is subjected to chemical treatment while the semiconductor wafer is placed in the closed processing cup such that openings of the via holes remain in contact with the circulating treatment fluid.

11. The chemical treatment system according to claim 1, wherein the member to be subjected to treatment is a printed board; the printed board has a plurality of through holes which are closed at one end and open at the other end; and a surface of the semiconductor wafer, including interior surfaces of the through holes, is subjected to chemical treatment while the semiconductor wafer is placed in the closed processing cup such that openings of the through holes remain in contact with the circulating treatment fluid.
